(19) United States
(12) Patent Application Publication
(10) Pub. No.: US 2009/0210353 A1
(43) Pub. Date: Aug. 20, 2009

(54) WEATHER FORECAST SYSTEM AND METHOD

(75) Inventors: Stephen John Mitchell, Bellaire, TX (US); Aaron Studwell, Kelley Green, CT (US)

Correspondence Address: HAYNES AND BOONE, LLP;IP Section, 2323 Victory Avenue, Suite 700, Dallas, TX, 75219, US

(73) Assignee: WEATHER INSIGHT, L.P., Houston, TX (US)

(21) Appl. No.: 12/348,152

(22) Filed: Jan. 2, 2009

Related U.S. Application Data
(60) Provisional application No. 61/018,623, filed on Jan. 2, 2008.

(51) Int. Cl. G06Q 40/00; G01W 1/00; G06F 3/048

(52) U.S. Cl. 705/36 R; 340/601; 715/771

(57) ABSTRACT

A method and system configured to receive, process, compile, and transmit weather information to selected users is provided. The weather information is generally received from a remote weather information database, processed by at least one real-time data server, and transmitted through a communication module to a plurality of users in accordance with predetermined parameters that may be set by the users themselves.

### CROSS-REFERENCE TO RELATED APPLICATIONS

This application claims the benefit of provisional patent application U.S. Ser. No. 61/018,623 filed Jan. 2, 2008 by the present inventors, the contents of which are hereby expressly incorporated by reference in its entirety.

### BACKGROUND OF THE INVENTION

Most commodities traded on an exchange floor are influenced in some way by the weather. Energy, for example, is a particularly weather-sensitive commodity that is publicly traded on national and international market platforms. In order to better facilitate the trading of weather-dependent commodities, several entities around the globe consistently distribute weather forecasts whose forecast parameters can be applied to commodity trading. For example, the National Weather Service (NWS) regularly issues to the public a comprehensive package of weather-related information, including extended forecasts for various regions. Generally, the NWS makes weather information, including weather forecasts, available up to 364 hours in the future in 3-hour increments. As soon as the weather information is made available, the information is downloaded to a public FTP server where it is made available to the public for various uses.

From the various weather forecasts, national maps portraying forecast changes may be generated, usually by meteorologists. A trained meteorologist may then analyze the forecast change maps to create conclusory opinions regarding future weather trends in various geographic locations. Using these conclusory opinions, a typical energy-commodity trader on the floor of an exchange may then make informed decisions on whether to buy or sell an energy commodity. For instance, if colder weather is forecasted for the upcoming winter based upon directional momentum, traders may decide to buy more of a commodity that is used in colder weather, such as natural gas.

However, several significant drawbacks are present in this conventional process. One drawback is that a meteorologist, although extensively trained, is prone to potential mistakes as a result of miscalculations or simply misreading a forecast. Another drawback is the time it takes to obtain a weather forecast, have it reviewed by a meteorologist, and interpret the extended forecast as it relates to energy commodities. In most instances, this process can take up to 15 minutes from the time when the government weather forecast is provided into the pubic domain to the time where an individual actually sees the market move. Consequently, the benefits associated with trading weather-related commodities can be maximized by reducing human error and the overall processing time.

Therefore, there is a need for an improved system and method capable of delivering weather forecasts in near real-time, and designed to eliminate the human decision-making element from the process. By doing so, the relevant information can be distributed to both screen traders and the traders on the exchange floor in a more expeditious manner, thus allowing traders to make trade decisions ahead of the market moving in response to the release of weather related information

### SUMMARY OF THE DISCLOSURE

In one embodiment of the present disclosure, a method for compiling and transmitting weather-related data to a commodity trader is disclosed. The method may include polling a weather information database for current and updated weather data, retrieving the weather data in or about real-time from the weather information database, transmitting the weather data to a real-time data server, compiling and converting the weather data into at least one weather product, and transmitting the at least one weather product from a communication module to the commodity trader, in about real-time.

In another embodiment of the present disclosure, a system for delivering weather-based informational content to a commodity trader is disclosed. The system may include at least one real-time data server configured to retrieve and compile weather forecast data from a weather information database, a communication module communicably coupled to the at least one real-time data server and configured to develop at least one weather product, and a user input module communicably coupled to the communication module and configured to allow the commodity trader to set up pre-defined delivery conditions to customize receipt of the at least one weather product from the communication module, such that an individualized weather forecast may be transmitted to the commodity trader.

In yet another embodiment of the present disclosure, a system for delivering weather-based informational content to a commodity trader may be disclosed. The system may include means for retrieving and compiling weather forecast data from a weather information database, means for developing at least one weather product, and means for allowing the commodity trader to set up pre-defined delivery conditions to customize receipt of the at least one weather product from the communication module, such that an individualized weather forecast may be transmitted to the commodity trader.

### BRIEF DESCRIPTION OF THE DRAWINGS

FIG. 1 illustrates a schematic of an exemplary weather forecasting system according to one or more embodiments of the present disclosure;

FIG. 2 illustrates a schematic of an exemplary method of compiling and sending real-time weather data forecasts to a user;

FIG. 3 illustrates a schematic of an exemplary embodiment of the communication module as shown in FIG. 1.

FIG. 4 illustrates a graphical user interface for an exemplary near real-time data spreadsheet illustrating some of the temperature forecasts of the disclosure;

FIG. 5 illustrates a graphical user interface for an exemplary embodiment of a web-based application for creating near real-time weather data as it relates to trading of natural gas commodities;

FIG. 6 illustrates a graphical user interface for an exemplary embodiment of a web-based application illustrating temperature forecast trends; and

FIG. 7 illustrates a graphical user interface for an exemplary embodiment of a web-based application illustrating forecasts relating to national weather maps.

### DETAILED DESCRIPTION

Prior to addressing the various embodiments of the disclosure, it is to be understood that the following disclosure provides many different embodiments or examples for implementing different features of various embodiments of the invention. Although exemplary configurations components and methodologies for practicing embodiments of the invention are described below, the described embodiments are intended to be only exemplary of the invention and not intended to be limiting upon the scope of the invention. Additionally, the present disclosure may repeat reference numerals and/or letters in describing the various exemplary embodiments of the invention in several Figures noted above. However, this repetition is merely for the purpose of simplicity and clarity, and is not intended in itself to represent a relationship between the various embodiments and/or configurations discussed herein. Moreover, the invention, is not limited to any specifically described embodiment or configuration of elements. Rather, any combination of the following features and elements, whether related to a described embodiment or not, may be used to implement and/or practice the invention.

Additionally, in various embodiments, the invention may provide advantages over the prior art; however, although embodiments of the invention may achieve advantages over other possible solutions and the prior art, whether a particular advantage is achieved by a given embodiment is not intended in any way to limit the scope of the invention. Thus, the following aspects, features, embodiments, and advantages are intended to be merely illustrative of the invention and are not considered elements or limitations of the appended claims; except where explicitly recited in a claim. Similarly, references to “the disclosure” herein should neither be construed as a generalization of any inventive subject matter disclosed herein nor considered an element or limitation of the appended claims, except where explicitly recited in a claim.

Further, at least one embodiment of the invention may be implemented as a program product for use with a computer system or processor. The program product may define functions of the exemplary embodiments (which may include methods) described herein and can be contained on a variety of computer readable media. Illustrative computer readable media include, without limitation, (i) information permanently stored on non-writable storage media (e.g., read-only memory devices within a computer such as CD-ROM disks readable by a CD-ROM drive); (ii) alterable information stored on writable storage media (e.g., computer disks for use with a disk drive or hard-disk drive, writable CD-ROM disks and DVD disks, zip disks, portable memory devices, and any other device configured to store digital data); and (iii) information conveyed across communications media, (e.g., a computer, telephone, wired network, or wireless network). These embodiments may include information shared over the Internet or other computer networks. Such computer readable media, when carrying computer-readable instructions that perform methods of the invention, may represent embodiments of the present invention.

Further still, in general, software routines or modules that implement embodiments of the invention may be part of an operating system or part of a specific application, component, program, module, object, or sequence of instructions, such as an executable script. Such software routines typically include a plurality of instructions capable of being performed using a computer system or other type or processor configured to execute instructions from a computer readable medium. Also, programs typically include or interface with variables, data structures, etc., that reside in a memory or on storage devices as part of their operation. In addition, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways.

Embodiments of the present disclosure generally allow a user to bypass the time-consuming weather analysis and forecasting steps that are part of the conventional weather-related trading processes. Exemplary embodiments may provide a user with near real-time weather data using a system and method configured to evaluate forecasted weather and convert it into near real-time forecasted commodity related trading information. Exemplary embodiments may provide the user with the information in a variety of trader-friendly text and graphical formats.

While the various embodiments disclosed below may include benefits to trading commodities, such as energy products, it is to be understood that the present disclosure may further extend to all traded futures, options, equity and various traded indexes, without departing from the intended scope.

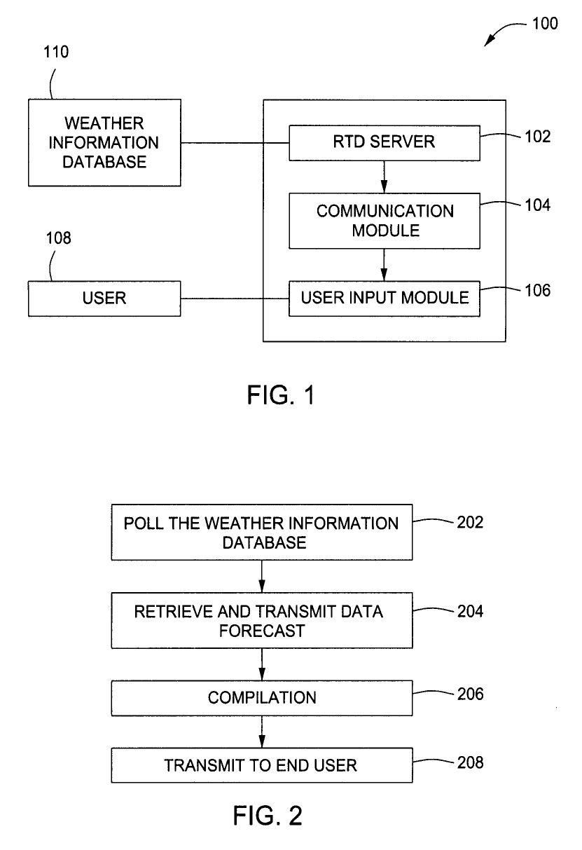

Referring now to FIG. 1, illustrated is a schematic of an exemplary weather forecasting system 100 of the invention. The weather forecasting system 100 generally includes at least one real-time data (RTD) server 102, a communication module 104, and a user input module 106. In an exemplary embodiment, the RTD server 102 may include a computer server or similar data processing machine, and be configured to retrieve and compile weather forecast data and provide that data to the communication module 104 at or near real-time speed. The communication module 104, in turn, may be configured to compile the weather information received from the RTD server 102 and develop at least one weather product. Once developed, the weather products may be distributed to a user 108 in a variety of formats through the user input module 106. The user input module 106 allows a user 108 to customize the receipt of the compiled weather information from the communication module 104, such that an individualized forecast may be transmitted to each user 108. In an exemplary embodiment, the user 108 may include a commodity trader on the floor of a market exchange.

In an exemplary embodiment of operation, the RTD server 102 may be operably connected to at least one weather information database 110 configured to receive its weather information from a plurality of sources, such as, government weather sources (i.e., the National Oceanic Atmospheric Administration (NOAA), the National Weather Service (NWS)), other government funding research facilities, educational institutions, privately operated weather sources, and various other public or private meteorological information sources. In an exemplary embodiment, the current weather data may be made available to the weather information database 110 at set of predetermined time intervals. Around these predetermined time intervals, the RTD server 102 may continuously poll and check the weather information database 110 for any forecast updates, and once made available to the weather information database 110, the RTD server 102 may immediately acquire the data in near real-time. Once the data is retrieved by the RTD server 102, it may be disseminated to at least one user 108, at or near real-time, through the communication module 104 and user input module 106.

In an exemplary embodiment of operation, each mode of data dissemination through the communication module 104 is generated, at least in some degree, by employing Microsoft Office Excel® RTD technology in the RTD server 102. Specifically, Excel® provides a worksheet function, generally referred to as “RTD,” that allows a user to assign a particular cell in a spreadsheet to a particular value, where the value is determined by calling a server and retrieving data associated with the particular cell. In embodiments of the present disclosure, the RTD server 102 may be designed to allow a preconfigured Excel® spreadsheet to retrieve real-time weather forecast data from the weather information database 110, and be configured to continually update based upon the most recent data available from the weather information database 110. In an exemplary embodiment, this process may continuously transmit weather-related data while the Excel® spreadsheet is open. In other words, the RTD spreadsheet may be dynamic in that the values in the spreadsheet may be continually changing to reflect the most recent weather data available.

Referring now to FIG. 2, illustrated is a schematic of an exemplary method of compiling and sending real-time weather data forecasts to a user 108. When employing the RTD function as explained above, the RTD server 102 may continuously poll the weather information database 110 for current and updated weather data and forecasts, as in step 202. Once any new information is detected, the RTD server 102 automatically retrieves and transmits the weather data and forecasts, in or about real-time, from the weather information database 110 to the RTD server 102, as in step 204. The weather data may be transmitted via a land-line Internet connection, a privately-dedicated connection to the National Weather Service (NWS), or any high-speed data connection. In other examples, information may be transmitted via public connections to other forecast sources, and even via satellite, although these types of connections are generally slower than private connections to the NWS. Using the Microsoft Office Excel® RTD technology as described above, the RTD server 102 may compile 206 the retrieved weather data forecasts from the weather information database 110 and provide the compiled data to the communication module 104 for transmission of a plurality of weather products. Once compiled and converted into at least one weather product, the weather data may then be transmitted 208 to an end user via a variety of communication channels and configurations, as described below.

During the compilation process 206 of the forecasted weather data, the RTD server 102 may also execute conversions or calculations of the real-time data related to specifically-traded financial contracts. Such financial contracts may include commodities, but may also include all traded futures, options, equity and various traded indexes. For example, the RTD server 102 may be configured to convert the temperature forecast data into a real-time forecast of billion cubic feet (bcf) of natural gas being stored in the United States. This forecasted storage value may then be used by a trader to make an informed trading decision, and because the analysis is in real-time, the trader may do so prior to the market moving in response to conventional analysis and forecasting techniques.

As further explanation, in an exemplary embodiment of operation, the aggregate average forecasted temperature from select U.S. cities or regions may be compiled by the RTD server 102 as described above. The data compilation may then be converted to a value representing the forecasted natural gas storage change by applying the following gas demand algorithm:

y=−7×10⁻⁵x⁴+0.012x³−0.9833x²+53.1x−1336.1
(where “y” is the storage change and “x” is the temperature)

Once calculated, these forecasted numbers may then be compared against past U.S. reported natural gas storage numbers to determine a possible change in the trend as a result of the updated forecast information. Past U.S. reported natural gas storage numbers may be derived from readily available Internet websites hosted by the Energy Information Association (EIA), and can be downloaded automatically. A comparison of the historical data versus the forecasted data supplies a trader with a fairly reliable forecast trend for the amount of U.S. natural gas storage in response to historical similarly forecasted weather conditions. Therefore, the present disclosure may allow a trader to convert current influential weather forecast information into an actionable energy-trading strategy without the delays associated with conventional methods that currently include time-consuming meteorologists and analyst inputs.

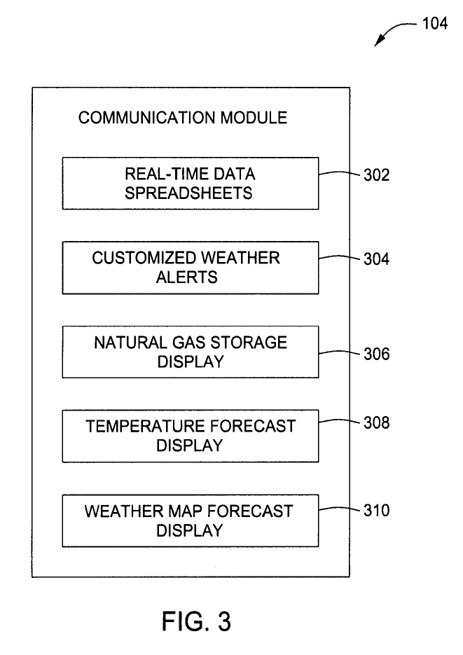

Referring now to FIG. 3, illustrated is an exemplary schematic embodiment of the communication module 104, as show in FIG. 1. As described above, the communication module 104 may be configured to receive the compiled real-time data from the RTD server 102 and develop a series of weather products that may be distributed to the individual users 108 by way of the user input module 106. As shown in FIG. 3, at least some of the weather products developed by the communication module 104, that are capable of being distributed to a user 108, may include real-time data spreadsheets 302, customized weather alerts 304, statistical and graphical depictions of natural gas storage 306, a temperature forecast period web-based application display 308, or a forecast weather map web-based application display 310.

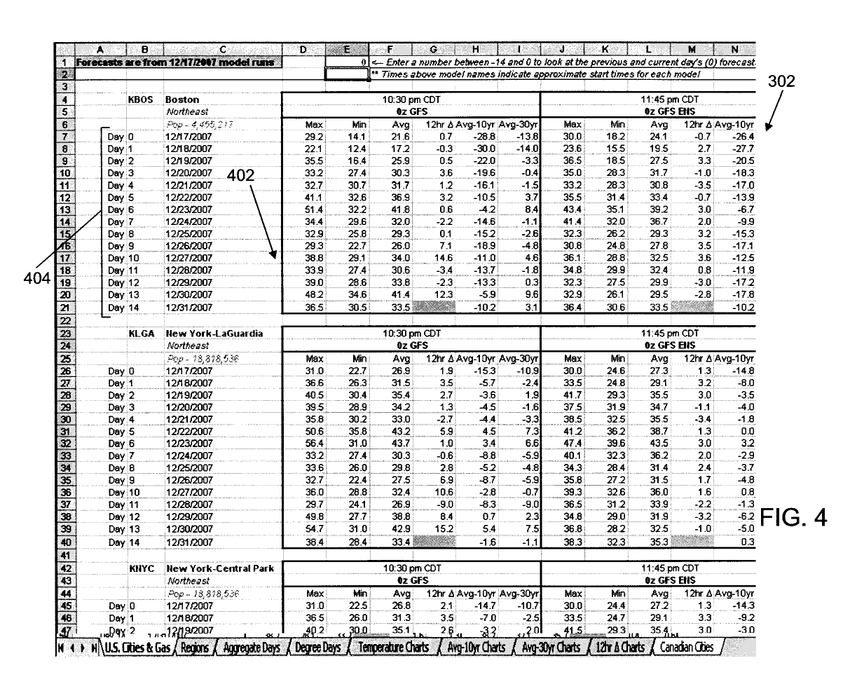

Referring to FIG. 4, illustrated is an exemplary embodiment of a real-time data spreadsheet 302 in the form of a graphical user interface. As described above, the exemplary spreadsheet may employ Microsoft Office Excel® RTD technology that is configured to provide a user 108 with dynamic weather forecast information changeable in real-time.

With reference to FIG. 4, the meteorological industry recognizes at least three basic weather models that provide traders and meteorologists with current weather forecasts: the Global Forecast System (GFS), the Global Forecast System Ensemble (GFS ENS), and the European Centre for Medium-Range Weather Forecasts Ensemble (ECMWF ENS). Each model releases forecast data at least two times per day, i.e., in the morning and in the evening, and each model does so at varying times. For example, the GFS may release forecast information at 10:30 am and 10:30 pm (CDT), the GFS ENS may release forecast information at 11:45 am and 11:45 pm (CDT), and the ECMWF ENS may release forecast information at 3:15 am and 3:15 pm (CDT). Since the spreadsheet 302 is supported by the RTD technology as described above, the spreadsheet 302 is constantly updating throughout any given day as the varying weather model forecast information is released and retrieved by the RTD server 102. The tracking on the real-time data spreadsheet 302, therefore, flows continuously from day to day during six consecutive, but not necessarily equal, time-intervals. In an exemplary embodiment, the RTD server 102 may update the spreadsheet 302 data every 15 seconds, but may execute updates in longer or shorter time intervals as selected by the user or an administrator.

In one embodiment, a real-time data spreadsheet 302 may include and display real-time temperature charts 402 made available to the user via the Internet or any other medium capable of supporting RTD technology. Through the spreadsheet 302, temperature forecast information for several cities or regions may be provided. In one embodiment, cities may include, for example, Boston, New York City (Central Park area), New York City (LaGuardia area), Philadelphia, Cincinnati, Chicago, Atlanta, Orlando, Dallas, Houston, Pueblo, Colo., Phoenix, Bakersfield, and Sacramento. In alternative embodiments, several other cities may be included in the spreadsheet 302, or the spreadsheet 302 may be modified by the user 108 to include data for only a few specific cities. In another embodiment, the spreadsheet 302 may display information for cities located in foreign countries. In yet another embodiment, the spreadsheet 302 may display data for specific population-weighted geographic regions, i.e., the northeast, the upper Midwest, Texas, the southeast, the Rockies, the west, or the entire United States that pertain to natural gas trading regions. Other versions of the spreadsheet 302 may display weather forecasts for power trading regions or specific agricultural crop growing regions.

In one exemplary embodiment, the spreadsheet 302 temperature forecast information for the example cities is made available for a 15 day period 404, which is the period generally recognized in the meteorological industry as an extended forecast period. For example, day zero information indicates weather forecast data for the current day, day one refers to tomorrow's forecast data, day two displays data for two days in the future, and so on, continuing until day 14. A selected day's temperature input represents the current day forecast given by a respective model for the selected day. For example, a day 5 temperature input under the GFS model represents what the GFS model, today, prognosticates will be the temperature 5 days from today. Therefore, if a trader in the marketplace desires to foresee how energy commodities may be affected based on weather patterns 5 days from now, the trader can reference a temperature forecast 5 days out. In yet a further embodiment, the spreadsheet 302 may also roll up the time periods into three industry-recognized time groupings, i.e., days 1-5, 6-10 and 11-14, and provide forecast data from the three basic weather models with the ability to incorporate additional weather forecast models into the same defined outputs.

In alternative embodiments, the spreadsheet 302 temperature forecast information for the example cities may be made available for a 32 day weather forecast. The 32 day forecast may be incorporated from both the NOM and the ECMWF ENS, and may be displayed on the spreadsheet 302 in a similar fashion as the 15 day forecast.

In another exemplary embodiment, the real-time data spreadsheet 302 may provide and continuously update the forecasted daily maximum/minimum temperatures, daily average temperatures, the change in temperature from the previous forecast occurring 12 hours ago, the daily average temperature departure from the 10 year average, the daily average temperature departure from the 30 year average, current forecasted temperature as it departs from last year's observed temperature, 850 mb temperature, forecasted humidity, forecasted dew point, forecasted wind speed, wind direction, forecasted feels-like temperature, and forecasted heights for various pressure layers over given cities. In another exemplary embodiment, the spreadsheet 302 may provide similar data for the three industry-recognized time groupings, i.e., days 1-5, 6-10 and 11-14. In this embodiment, the 12 hour forecast change, and the 10 and 30 year average departure changes in temperature may be color coded; i.e., digitally displayed red-colored temperature readings indicate a warmer forecasted change, and blue-colored temperature readings indicate a cooler forecasted change. Further to this embodiment, the spreadsheet 302 may also make available maximum, minimum, and average temperature forecasts for any specific time grouping.

In the event that a full week of data is not yet available, an exemplary spreadsheet 302 may automatically report the maximum/minimum temperatures and the average temperature from the data points currently available while awaiting updated data. For example, if only 3 days of forecast data are currently available, the spreadsheet 302 may calculate the max/min and average temperatures for the available 3 days of data while awaiting updated data for days 3+.

In another exemplary embodiment of the spreadsheet 302, a user may be provided with forecast data regarding the industry-recognized Heating Degree Days (HDD) and Cooling Degree Days (CDD). In the marketplace, there are weather financial instruments that are linked to HDD's and CDD's, and traders commonly buy and/or sell aggregate amounts of degree days depending on the forecasted temperatures. By way of explanation, a HDD occurs when the weather is cold enough to activate heating devices, and a CDD occurs when the weather is warm enough to activate cooling devices (i.e., air conditioning). In an exemplary embodiment, 65° F. may be the norm, meaning that any daily average temperature that is above 65° F. is a CDD, and if it is below 65° F. it is a HDD. The CDD/HDD value is calculated from the difference between the forecasted average daily temperature and the norm (65° F.). For example, if the forecasted average is above 65° F., the numerical difference will appear in a CDD column with respect to a specific city or region. Also cumulative Degree Days may be calculated and displayed by adding all HDD's or all CDD's for a specific month of a given city. Since HDD's and CDD's are regularly traded in the marketplace, this real-time data information may prove useful to a trader in the industry.

In another exemplary embodiment, in lieu of viewing real-time streaming data numerals for cities or regions, a user 108 may also view equivalent weather bar charts. Because the temperature bar charts may be simultaneously created from the forecast data displayed on the spreadsheet 302, the weather bar charts may also be continuously updated by the RTD server 102. In one example, the weather bar charts may be grouped into the three industry-recognized time groupings, i.e., days 1-5, 6-10 and 11-14. In another example, each weather bar chart may display information for an individual day, or time period, such as a balance-of-the week, next week, or balance-of-the-month. Using those time groupings as a basis, available weather bar charts may include, but are not limited to: charts reflecting the 12 hour temperature forecast change for a city/region; and charts reflecting the 10 and 30 year average departure changes in temperature for a city/region. Other exemplary weather bar charts may include the same general format as described above, the y-axis representing some departure from climatology such as 10, 15, or 30 years, and the x-axis representing the various groupings. In an exemplary embodiment, the x-axis groupings may be adjusted to represent power trading regions, gas trading regions, or agricultural crop growing regions. Within each grouping there may be specific colored bars, each representative of a different weather forecast model for the same time period, which ultimately makes for easy comparison.

Line charts may also be provided indicating: the daily temperature forecasts (commencing on day zero [today] through day 14) reflecting results for the 12 hour temperature forecast change; and the 10 and 30 year average departure changes in temperature. In an exemplary embodiment, a user can customize and personalize all bar and line charts to fit specific trading needs. These charts may be useful to commodity traders as a quick reference tool to determine trading strategies for energy commodities.

In an alternative exemplary embodiment, the real-time data spreadsheet 302 may be updated using preliminary daily averages to accelerate the forecast process delivered to the user 108. As an explanation, the GFS model of the NWS continuously produces a weather forecast 384 hours into the future in 3 hour intervals. The first hour made available is hour 3, then hour 6, then hour 9, and so on until hour 384, or 15 days into the future. For each day (24 hour period), the NWS outputs the “true” daily max/min temperatures for the preceding 24 hours at hour 30, or 6 hours after the day has technically ended. However, according to the present disclosure, since the minimum and maximum temperatures throughout a day can be isolated to specific times during the 24 hour period, preliminary daily min/max and average calculations may be executed and return approximated values. For example, the daily minimum temperature will typically be hit within the first 12 hours of the day, during interval hours 6 and 9, and the daily maximum temperature will typically be hit within the last 12 hours of the day, during intervals 18 and 21.

In exemplary operation, once the NWS releases the temperature data for hours 6 and 9, and hours 18 and 21, the RTD server 102 may be configured to take those released temperatures and calculate a preliminary “true” daily min/max and average. In conjunction with the preliminary “true” daily min/max and average, the spreadsheet 302 may include a “% complete” field that displays, in real-time, how complete the process is from turning a preliminary calculation into the “true” or official record. With the approximate daily min/max and average, the RTD server 102 may further be configured to compile the forecast data for each released hour and generate city forecasts and national maps (as described below). Unless an anomalistic weather front blows into a specific region and changes the weather dramatically, these averages may be calculated with fair accuracy. In some instances, this may provide the trader with a significant time advantage over competitors in the marketplace.

Moreover, as can be appreciated, similar “% complete” fields may be implemented for other forecast variables, such as humidity and wind, without departing from the scope of the present disclosure. Similarly, by linking the “% complete” for the respective forecast variables, a user 108 may further be provided with a “feels-like” temperature “% complete” field.

In an exemplary embodiment, specific portions of the preceding embodiments and displays, potentially available in the real-time data spreadsheet 302, may be combined into a single display page, or graphical user interface (GUI), configured to provide a user 108 with core weather information and market moving knowledge all in a single view. In one embodiment, this may be referred to as a “Trader Dashboard,” and may be available for view as a separate toggle tab at the bottom of the real-time data spreadsheet 302. Accordingly, the Trader Dashboard page may contain several hand-picked features of the overall spreadsheet 302, including a few features not part of the spreadsheet 302 (described below), combined into one view. In one embodiment, the Trader Dashboard may reflect information for certain commodities, such as, for example, natural gas. However, the Trader Dashboard may also be effectively implemented to reflect information for all types of markets, like energy, agriculture, or stocks.

According to an exemplary embodiment, the Trader Dashboard may include a plurality of weather bar charts and forecasted temperature data information charts specifically chosen by the user 108. In other words, the user 108 may personally determine which charts and energy trading regions are most important to the user's 108 trading strategy and combine those charts into a single view on the Trader Dashboard GUI. As described above, the weather bar charts may be configured to display instantaneous changes in a government weather forecast, thus providing a user 108 with detailed information useful for a quick, actionable weather-driven trade. Moreover, the temperature date information charts may be configured to aggregate into key energy trading regions a visual comparison between the 12z GFS, 12z GFS ENS, and 12z ECMWF ENS. These charts may be customizable into various agricultural growing regions as opposed to energy trading regions.

The Trader Dashboard may also include the download status of the several government weather forecast models for the day, introducing the preliminary daily max/min averages as described above. In short, the download status depicts the weather forecast progress as it is being made available to the public domain and provides a “% Complete” column configured to reflect the percentage that a “true” forecast has been given by a specific weather model for the particular forecast day.

Also potentially included in the Trader Dashboard may be trading indicator strategies. As explanation, the trading indicators may be configured to display “bullish” or “bearish” trading signals when the real-time data feeds from the RTD server 102 have been historically verified to move market price. The trading indicator technology is disclosed in jointly owned U.S. Provisional Pat. App. Ser. No. 66/079,745, filed on Jul. 10, 2008, and entitled “Commodity Trading System and Method,” the entire contents of which are incorporated herein by reference to the extent that it is not inconsistent with the present disclosure.

Another feature that may be included in the Trader Dashboard GUI may be a display of technical indicators configured to optimize fundamental-based trading strategies by incorporating the markets' consensus value (MC Value), as is well known in the art. The MC Value determines whether the market is “technically” bearish or bullish. The technical information may be provided by a third party source, in one embodiment. The MC Value may be combined with the trading indicators, as described above, which reveal the fundamental-based trade indicators (i.e., weather changes, etc.), to display how the market may respond to various signals and/or a combination of signals. Using this compound indicator, a combination of the technical and fundamental indicators, a user 108 may receive a more reliable forecast analysis. The compound indicator may further help to refine and time the entry and exit points in the market, thus allowing a user 108 to optimize trading strategies.

The Trader Dashboard may also incorporate an auto execution module, as known in the art as “algorithmic trading,” wherein the module is set at user 108 predefined parameters to buy or sell once an indicated bullish/bearish signal is achieved. As explanation, a user 108 may predefine how many contracts are to be bought or sold when certain events occur. The certain events may be tied directly to the bullish/bearish signals received by the trading indicator strategies and the compound indicators. The execution module may be employed on multiple electronic exchanges, and may be changed quickly to meet changing market trends.

The communication module 104 may further be capable of distributing compiled information to the user via customized weather alerts 304, designed for the trader who wants to be alerted when predetermined weather forecast criteria or parameters have been met. In an exemplary embodiment, weather alerts 304 may be written in structured syntax or sentence form and forwarded to predetermined users who have requested weather information related to a particular weather parameter or forecast information. In another exemplary embodiment, weather alerts 304 are available to a user through pop-up messages, e-mail, instant messenger services, text messaging, a BlackBerry® device, or any other hand-held digital device that may be used on the floor of a commodity exchange, thus allowing commodity traders to receive near real-time whether forecast information directly.

In one exemplary embodiment, the user-defined parameters of the customized weather alerts 304 may include information related to weather forecasts, such as geographic identifiers, or one or more temperature identifiers for alerting the user 108 in the event the temperature in a specific geographic region fluctuates to a pre-determined critical reading. In another exemplary embodiment of the weather alerts 304, a user 108 may customize alerts relative to weather events such as warm or cold weather, or even tropical storm activity. In yet another exemplary embodiment, a user 108 may be able to receive customizable alerts featuring power plant and/or refinery information, such as outages, as they relate to weather fluctuations. Importantly, the user 108 may be able to receive only what is asked for as opposed to being bombarded with instant messages and alerts that are unrelated to the trader's trading vision.

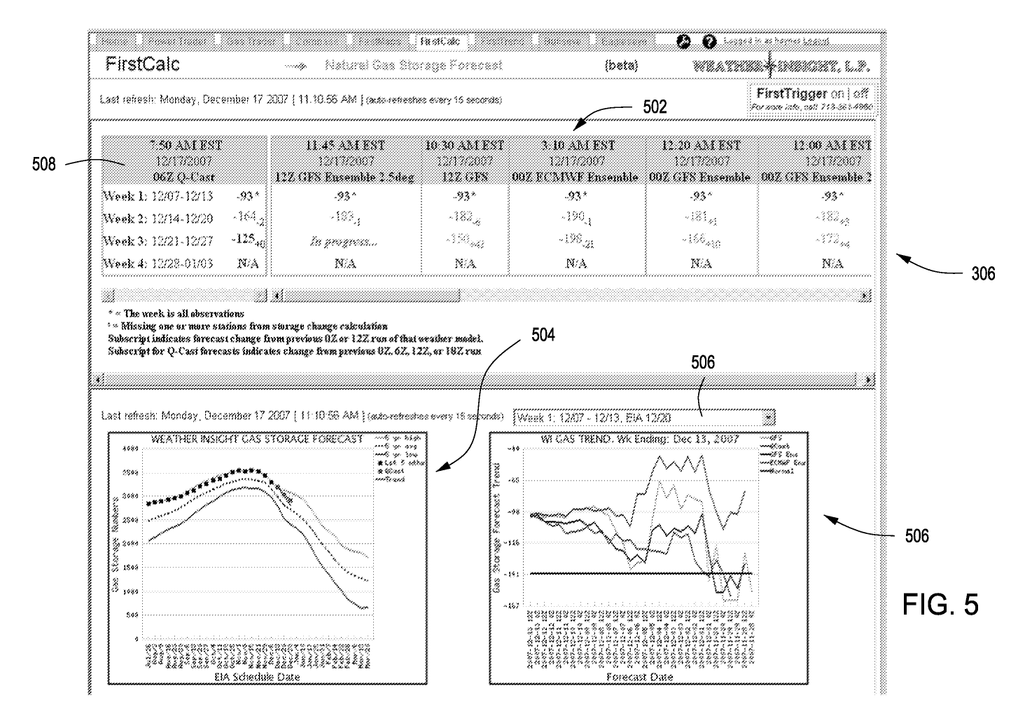

Referring now to FIG. 5, the communication module 104 may further disseminate forecast information via a natural gas and weather web-based application display 306. In an exemplary embodiment, display 306 may be designed to compare the change in forecasts for natural gas storage calculated from various weather models by employing the gas demand algorithm as discussed above. Alternatively, a user 108 may use a different algorithm either selected by the user 108 or by an administrator of the system. As can be seen, display 306 permits a user 108 to view temperature forecasts converted into billion cubic feet (bcf) of natural gas storage capacity in the United States. This is compared against past reported bcf of U.S. natural gas storage derived from the EIA. In alternative embodiments, display 306 may illustrate temperature forecasts converted into billion cubic feet (bcf) of natural gas storage capacity for foreign countries. Since this information may be transmitted directly to traders via the RTD server 102 in near real-time, the timing and format of this information, as explained below, may afford a significant advantage to traders, as they are able to execute trades in the commodity markets prior to the point where weather trends begin an actual shift in the market.

Because display 306 continuously receives information from the RTD server 102, the information displayed therein is continuously updated in real-time as new model weather forecasts are released to the weather information database 110. In one embodiment, the display 306 may be configured to auto-refresh every 15 seconds, and transmit this information directly to commodity traders, thus allowing the traders to have the most recent forecast information in as close to real-time as possible. Having this type of real-time information sent directly to the trader's desktop, in advance of changing conditions or trends in the commodity markets, provides a positive trading edge. Thus, these traders are able to provide a benefit to themselves, the investors, and their customers, which was not available via conventional methods and systems.

Still referring to FIG. 5, display 306 may include a table 502 and two line graphs 504, 506. In an exemplary embodiment, the table 502 may include at least four weeks of compiled forecast information, one week into the past, the current week, and two forecasted weeks. In alternative embodiments, as many as seven or more weeks may be displayed. As illustrated in FIG. 5, Week 1, represents past observations stemming from the publicly released gas storage amounts disseminated through the EIA. The following weeks (Weeks 2-4), illustrate the present disclosure's calculated forecast storage change numbers. The forecasted numbers are derived once enough days have been ingested, so as to provide a full Fri-Thurs (calendar days) week (e.g., Days −5 to +1 if today is Wednesday). As shown in the exemplary embodiment, the forecast information for the Weeks is displayed in connection with the various weather model release times, spanning approximately 48 hours of time.

In an exemplary embodiment, the table 502 may further include proprietary weather forecast called Q-Cast 508 which is a performance-weighted average of all the publicly available weather forecasts. Q-Cast 508 may be derived by taking the average of all the weather forecast models, but weighing the models that have historically performed well heavier than the models that have historically performed poorly. This results in a numerical temperature forecast value closer to what the actual-day reading will be. This value may then be converted into bcf of natural gas by using the gas demand algorithm, as defined above, or by using an alternative formula that may be later refined. As soon as the latest daily forecast model information is made available, it is immediately converted into bcf of natural gas storage and inputted into the respective Weeks adjacent to Q-Cast 508. In this way, a trader is able to see how the daily temperature forecasts match up against a more reliable formulaic source.

In an exemplary embodiment, as displayed in FIG. 5, each natural gas storage value may include subscripts indicating the bcf forecast change derived from the previous weather forecast model run. The values and their subscripts may be color-coded; green or red indicating an increase or decrease, respectively, of the previously forecasted bcf storage level; and a black color may indicate no forecast change from the previous model run. The color-coded values may be used by traders to quickly determine trends in the natural gas market without requiring a detailed analysis of the data from an analyst or meteorologist.

Still referring to FIG. 5, the two line graphs 504, 506 illustrate the natural gas storage forecast and trend, respectively, derived in the same manner as table 502. As illustrated, graph 504 may include about 8 months of data, including three continuous lines indicating EIA statistics for the U.S. natural gas storage 5 year high, 5 year low and 5 year average during the represented time period. Furthermore, the graph 504 may illustrate the previous 5 months of EIA disclosed natural gas storage values. In continuation to the EIA's reported values, the illustrated embodiment may further plot the above-mentioned Q-Cast forecasted natural gas storage values for trader reference. These Q-Cast values are plotted on the line graph contiguous to the EIA's reported values, and indicate the maximum and minimum forecasted storage values from the week's models over the past 24 hours. As further explanation, each future natural gas week's value calculated using the Q-Cast weather forecast may be graphically represented as a red square that can be easily compared with the 5-year storage levels disclosed by the EIA. Surrounding each red square may be bars extending above and below the red square and representing the range of natural gas storage levels calculated for that specific week and derived from all the other weather forecasts in the public domain.

Graph 506 may plot the natural gas storage change forecasts calculated in the upper table 502. In one embodiment, a drop-down menu 510 allows a user 108 to look 12 weeks into the past and 4 (or more) weeks ahead of the current EIA gas storage week, and display a selected week's trend. In particular, the graph 506 may show how each weather forecast has changed its perspective on the EIA's gas storage level every time the weather forecast was updated for that particular EIA gas week. Furthermore, the graph 506 may plot a normal line indicating what the natural gas storage level would be if the current temperatures were equal to the trailing 10 year climatology for the same time period selected, which allows the user 108 to see how the current forecasts depart. In another embodiment, the prior year's historical trend may be provided in the form of a plotted line, in the event a trader trades year on year.

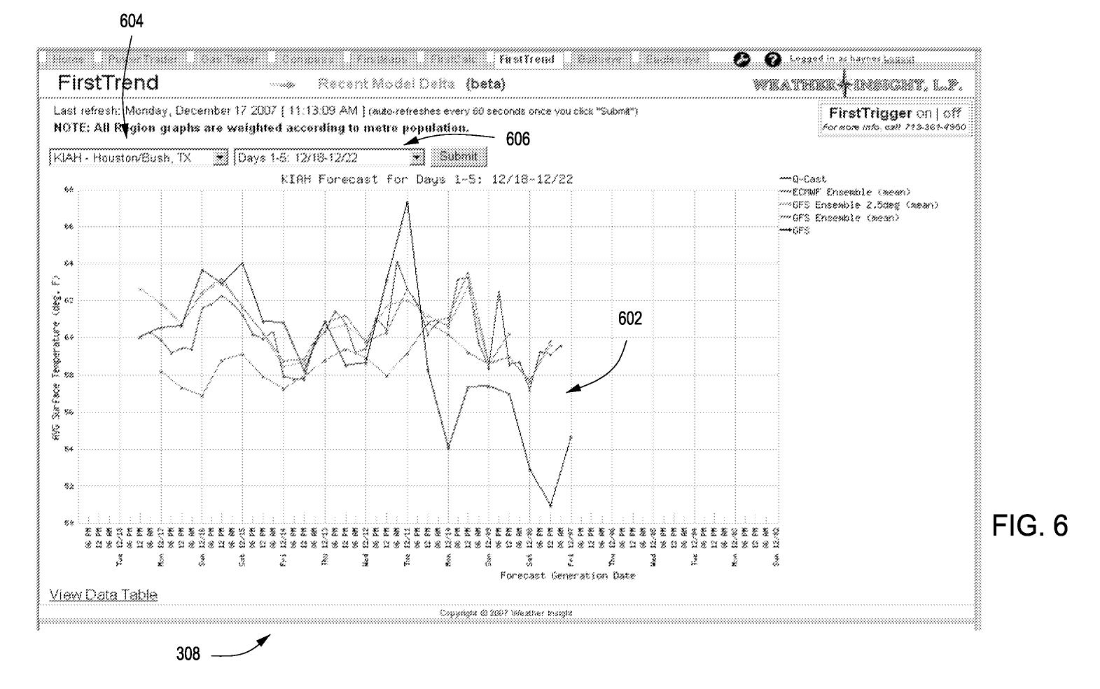

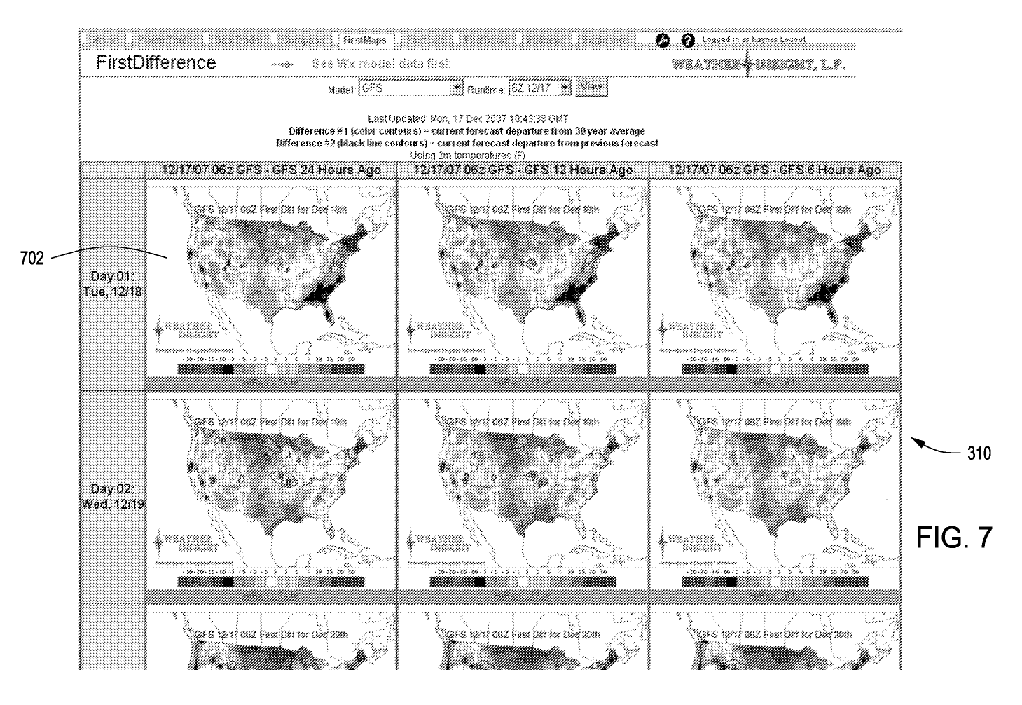

Referring now to FIG. 6, the communication module 104 may further include a forecast period web-based application display 308, illustrating graphical depictions of temperature change over a model forecast period. In other words, display 308 may make “live” weather forecasts easy to view with other time series data that may be correlated with weather forecasts; i.e., weather sensitive commodities such as natural gas, electricity, and heating oil. As shown in FIG. 7, display 308 may include a real-time graphic chart 602, generated on the fly, presenting the user with a graph depicting how a model's temperature forecast information has changed over the life of the model's forecast period, generally 15 days. In other embodiments, long-range modules may also be presented that depict how a model's temperature forecast information has changed over a period of 32 days or longer.

In an exemplary embodiment, the chart 602 may be read from right to left, with the left side of the chart 602 displaying the most recent forecast data. Data located on the right side of the chart 602 may illustrate the forecast model's earliest forecast period for the selected city/region. Since display 308 receives information from the RTD server 102, the data in the chart 602 is also continuously updated as new model weather forecasts are released. In one example, display 308 may auto-refresh every 60 seconds when the user selects a particular category to view, but may alternatively refresh at any time-period as subsequently designed by the user 108.

Two drop-down menus 604, 606 may also be provided in display 308. Menu 604 allows a user 108 to select a particular city or geographic region to view historic forecasted temperature values related thereto. Menu 606 allows a user 108 to alter the desired time period, or target date, displayed. In one example, menu 606 may allow model forecasts for individual days (out to 15 days in advance) to be selected and viewed. In another example, a user 108 may select from menu 606 several varying time periods that match different trader's needs. For example, some traders trade on industry recognized weeks, others trade on the balance of weeks (including Saturdays), and still others trade only on upcoming weeks. In another embodiment, a user 108 may also select from menu 606 a natural gas week corresponding to an upcoming EIA gas storage week in display 306.

Referring to the chart 602, each plotted point represents a weather forecast value for the time period and geographic region selected in the two drop-down menus 604, 606. For example, a user 108 may progress moving from right to left through the graph and see how various weather forecasting models have changed their forecasts as they come closer to the target time period. In one embodiment, display 308 may also plot temperature forecasts for at least four weather models and Q-Cast forecasted time values, as explained above with reference to display 306 in FIG. 5. Furthermore, display 308 may be a useful tool as it illustrates the volatility (or lack thereof) within a particular weather forecast model, thus providing a trader with more or less confidence in that model's forecasts. Accordingly, display 308 may grant forecast confidence to the trader, especially if two or three of the forecast models converge early and consistently forecast near the actual temperature values.

Referring now to FIG. 7, the communication module 104 may further include a web-based application display 310, depicting forecast weather maps 702. In an exemplary embodiment, display 310 may encompass geographic weather models illustrating temperature departure from the previous forecast and the 30 year average. In particular, display 310 comprises a plurality of graphical representations in the form of national weather maps 702 corresponding to varying times. In one embodiment, the weather maps 702 may illustrate the forecast out to the industry recognized 15 days. In alternative embodiments, the weather maps 702 may provide an illustrated forecast for up to 4 weeks into the future. Because display 310 receives information from the RTD server 102, the maps 702 are continuously updated as forecast model data is released and becomes available.

In one exemplary embodiment, display 310 is capable of showing whether the current weather forecast is significant by comparing it against a 30-year average. In exemplary operation, because the graphical representations in the national maps 702 depict departures from the 30 year normal, if the current forecast dramatically changes dramatically from a previous forecast, the trader can make informed decisions faster. For example, the national maps 702 may indicate new information or a change from the previous model run. Display 310 not only may display each forecast day, but may also roll up the time periods into the three industry-recognized time groupings, i.e., days 1-5, 6-10 and 11-14, and provide forecast data from several weather forecast models. Further, national map forecasts for balance of the week and weeks in advance may also be illustrated. In an alternative embodiment, maps may be generated for any region of the Earth as long as the meteorological data may be retrieved and processed.

In an alternative embodiment, the display 310 may be capable of determining and displaying how the current forecast has changed from previous forecast releases. For example, previous forecast releases may include forecasts released 6, 12, 24, 48, and 72 hours in the past. Knowing these changes may give a trader a positive edge for short-term trading strategies.

As an example, as the NWS updates the weather forecasts, embodiments of the invention may provide for the NWS information to be immediately downloaded and transmitted to a data server designed to electronically compile the forecasts. The compiled forecasts may then proceed directly into a trader's execution platform and, in at least one embodiment, the forecasts are converted into real-time forecasted natural gas storage numbers or integrated into other analysis tools. In another embodiment, by transmitting weather forecast data in real-time, the present disclosure automates the decisions that a trader/meteorologist would do in marketplace. In this manner, the present disclosure collapses the amount of time required to convert influential weather forecast information into an actionable trading strategy.

In at least one embodiment of the invention, a method for compiling and transmitting weather related data to commodity traders may be provided. The method may include downloading information from a weather information database, such as a database that is in communication with the NWS. The information may be downloaded from the database at predetermined intervals, or the intervals may be determined to correspond to specific times when the NWS is scheduled to update the weather forecast data. Once updated weather data or forecast information has been downloaded, the method of the invention may proceed to process and compile the weather data and forecast information. The process and compiling may include executing a plurality of algorithms configured to sort and/or prioritize the weather data and forecasts. The process of sorting and prioritizing the weather data may generally be conducted by a computer, such that human analysts and meteorologists are not required. Once the data has been compiled, the method of the invention may proceed to transmit the compiled information to selected users, where the users may be commodity traders. Additionally, the users may specify pre-determined parameters, forecasts, or portions of data that they wish to receive in various selected formats.

Another embodiment of the invention may provide a software package configured to control the method described above.

Another embodiment of the invention may provide a system for acquiring, generating, and transmitting whether data and forecast information to selected users. The system may include an input module, and RTD server module, and a communication module, all of which may be in communication with a remotely positioned weather information database. The system may be configured to receive weather information from the weather information database, process and compile the weather information in accordance with predetermined algorithms, and transmit the processed and compiled weather information to selected users.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A method for compiling and transmitting weather-related data to a commodity trader, comprising:
polling a weather information database for current and updated weather data;
retrieving the weather data in or about real-time from the weather information database;
transmitting the weather data to a real-time data server;
compiling and converting the weather data into at least one weather product; and
transmitting the at least one weather product from a communication module to the commodity trader, in about real-time.

2. The method of claim 1, wherein the weather information database is a government weather source.

3. The method of claim 1, wherein the real-time weather data is transmitted to the real-time data server via a high speed connection communicably coupled to the weather information database.

4. The method of claim 1, wherein the real-time data server compiles the real-time weather data using MICROSOFT OFFICE EXCEL real-time data technology.

5. The method of claim 1, further comprising converting the real-time weather data into a real-time forecast of natural gas being stored in a geographic region.

6. The method of claim 1, further comprising allowing the commodity trader to set up pre-defined delivery conditions to customize receipt of the at least one weather product from the communication module through a user input module, such that an individualized weather forecast may be transmitted to the commodity trader.

7. The method of claim 1, wherein the real-time data server is further configured to approximate a preliminary daily minimum temperature and a preliminary daily maximum temperature, wherein the preliminary daily minimum temperature is approximated from the temperatures recorded during the hours of the day when the lowest temperatures are typically met, and the preliminary daily maximum temperature may be approximated from the temperatures recorded during the hours of the day when the highest temperatures are typically met, wherein the preliminary daily minimum and maximum temperatures are released before the weather information database releases the true daily minimum and maximum temperatures.

8. A system for delivering weather-based informational content to a commodity trader, comprising:
at least one real-time data server configured to retrieve and compile weather forecast data from a weather information database;
a communication module communicably coupled to the at least one real-time data server and configured to develop at least one weather product; and
a user input module communicably coupled to the communication module and configured to allow the commodity trader to set up pre-defined delivery conditions to customize receipt of the at least one weather product from the communication module, such that an individualized weather forecast may be transmitted to the commodity trader.

9. The system of claim 8, wherein the weather information database is a government weather source.

10. The system of claim 8, wherein the at least one real-time data server uses MICROSOFT OFFICE EXCEL real-time data technology to continuously poll and check the weather information database for updated weather forecast data, thereby immediately acquiring any updated weather forecast data in or about real-time.

11. The system of claim 10, wherein the updated weather forecast data is disseminated to at least one commodity trader, at or about real-time, through the communication module and user input module.

12. The system of claim 8, wherein the at least one real-time data server is further configured to execute a plurality of algorithms configured to convert the retrieved weather forecast data into a real-time forecast of a measure of natural gas storage for a predefined geographical area.

13. The system of claim 8, wherein the at least one weather product of the communication module comprises at least one real-time data spreadsheet employing MICROSOFT OFFICE EXCEL real-time data technology, and thereby configured to provide a dynamic weather forecast changeable in real-time.

14. The system of claim 13, wherein the at least one real-time data spreadsheet comprises a graphical user interface having a plurality of real-time temperature charts and real-time line and bar charts, wherein the real-time temperature, line, and bar charts are configured to indicate weather forecast information for a plurality of cities or regions.

15. The system of claim 14, wherein the plurality of real-time temperature charts provide the forecasted daily maximum/minimum temperatures, the daily average temperatures, the change in temperature from the previous forecast occurring 12 hours prior, the daily average temperature departure from the 10 year average, and the daily average temperature departure from the 30 year average.

16. The system of claim 15, wherein each of the change in temperature from the previous forecast occurring 12 hours prior, the daily average temperature departure from the 10 year average, and the daily average temperature departure from the 30 year average may be color coded, whereby a first color indicates a warmer forecasted change, and a second color indicates a cooler forecasted change.

17. The system of claim 13, wherein the at least one real-time data spreadsheet comprises a graphical user interface indicating heating degree days and cooling degree days.

18. The system of claim 8, wherein the at least one real-time data server is further configured to provide a preliminary daily minimum and maximum temperature forecast by approximating daily temperature minimums and maximums before the weather information database releases the actual daily minimum and maximum temperatures.

19. The system of claim 8, wherein the at least one weather product of the communication module comprises at least one customized weather alert configured to alert a commodity trader when predetermined weather forecast criteria or parameters have been met.

20. The system of claim 19, wherein the at least one customized weather alert comprises electronic mail.

21. The system of claim 19, wherein the at least one customized weather alert comprises instant messaging services.

22. The system of claim 19, wherein the at least one customized weather alert is sent to a hand-held digital device.

23. The system of claim 19, wherein the predetermined weather forecast criteria comprises geographic identifiers, temperature identifiers, or tropical storm identifiers.

24. The system of claim 19, wherein the predetermined weather forecast criteria comprises power plant and/or refinery information, as they relate to weather fluctuations.

25. The system of claim 8, wherein the at least one weather product of the communication module comprises a statistical and graphical depiction of natural gas storage configured to compare the change in forecasts for natural gas storage against various temperature forecasts.

26. The system of claim 25, wherein the statistical and graphical depiction of natural gas storage comprises a graphical user interface showing the various temperature forecasts converted into natural gas storage capacity in the United States.

27. The system of claim 25, wherein the statistical and graphical depiction of natural gas storage comprises a plurality of graphical representations configured to show natural gas storage forecast and trend as compared with the prior reported values in the United States.

28. The system of claim 8, wherein the at least one weather product of the communication module comprises a temperature forecast period web-based application display configured as a graphical user interface illustrating forecasted temperature changes over a specified period.

29. The system of claim 28, wherein the graphical user interface allows the commodity trader to select a particular city or geographic region to view the forecasted temperature changes over a specified period.

30. The system of claim 8, wherein the at least one weather product of the communication module comprises a forecast weather map web-based application display configured to depict forecast weather maps for a plurality of cities and regions.

31. The system of claim 30, wherein the forecast weather maps are configured to illustrate a comparison between current weather forecasts and the recorded 30-year averages.

32. The system of claim 13, wherein the at least one real-time data spreadsheet comprises a single-view graphical user interface including a plurality of modules determined by the commodity trader, and configured to provide the commodity trader core weather information and market moving knowledge.

33. The system of claim 32, wherein the plurality of modules at least comprise:
weather bar charts configured to display instantaneous changes in a government weather forecast;
forecasted temperature data information charts;
a download status module depicting the weather forecast progress percentage as it is being made available to the public domain for a particular day;
trading indicator strategies configured to indicate bullish or bearish trading signals based on near real-time data feeds from the at least one real-time data server;
technical indicators configured to optimize fundamental-based trading strategies and create a compound indicator; and
an auto execution module configured to buy or sell once predefined parameters tied to the technical indicators are met.

34. A system for delivering weather-based informational content to a commodity trader, comprising:
means for retrieving and compiling weather forecast data from a weather information database;
means for developing at least one weather product; and
means for allowing the commodity trader to set up pre-defined delivery conditions to customize receipt of the at least one weather product from the communication module, such that an individualized weather forecast may be transmitted to the commodity trader.
